(19) United States
(12) Patent Application Publication
(10) Pub. No.: US 2011/0054880 A1
(43) Pub. Date: Mar. 3, 2011

(54) External Content Transformation

(75) Inventor: Christopher B. Fleizach, Santa Clara, CA (US)

(73) Assignee: Apple Inc.

(21) Appl. No.: 12/552,901

(22) Filed: Sep. 2, 2009

(51) Int. Cl. G06F 17/28; G06F 15/16; G10L 13/08

(52) U.S. Cl. 704/2; 709/246; 704/260; 704/E13.001

(57) ABSTRACT

Techniques and systems for content transformation between devices are disclosed. In one aspect, a system includes a host device that sends content to client devices, and client devices that receive content from the host device in one format and transform the content into a different format. The client devices present the transformed content to users. In another aspect, the host device presents content in a native format, determines that a client device requires the content to be in a different format, converts the content to a reference format, and sends the converted content to the client device.

### TECHNICAL FIELD

This subject matter is generally related to content transformation between devices.

### BACKGROUND

Computers and other devices are becoming increasingly capable of accommodating disabilities of individual users, as well as individual user preferences for how content is presented. For example, technologies such as screen reading software and electronic Braille devices make it possible for visually disabled users to experience content presented on a device that otherwise might be inaccessible to them.

However, these technologies typically only accommodate disabilities and/or preferences of a single user at a time. In addition, these technologies typically require the device presenting the content to assume the overhead of accommodating a user's needs and preferences.

### SUMMARY

Techniques and systems for content transformation between devices are disclosed. These techniques can be used to transform content presented on a host device into formats that satisfy the needs and preferences of users of client devices, especially disabled users. In one aspect, a system includes a host device that sends content to client devices, and client devices that receive content from the host device in one format and transform the content into a different format. The client devices present the transformed content to users. In another aspect, the host device presents content in a native format, determines that a client device requires the content to be in a different format, converts the content into a reference format, and sends the converted content to the client device.

Particular embodiments of the subject matter described in this specification can be implemented to realize one or more of the following advantages. Users of client devices can experience content received from the host device in user specified formats that are specific to each user. The formats can accommodate specific disabilities of the users, or specific preferences of the users. Multiple users can experience content at the same time, each according to their individual needs and preferences. A host device can share content with many users, without needing to do significant processing on the host device to accommodate users' needs and preferences. A host device can share content with many users having different needs and preferences, even when the host device is unable to accommodate the different needs and preferences. A host device can share content with many users having different needs and preferences, even when the host device is unaware of the different needs and preferences. Users that are remote from the host device can experience content presented on the host device according to their own needs and preferences. Content presented on a host device can be presented in a format that accommodates user needs and preferences in real-time, or can be stored for later presentation according to user needs and preferences. Content presented on a host device can be transformed multiple times in order to accommodate specific needs or preferences of a user.

### DESCRIPTION OF DRAWINGS

FIG. 1 illustrates an overview of an example system including a host device and multiple client devices.

FIG. 2 illustrates an example architecture of the system illustrated in FIG. 1.

FIG. 3 illustrates an example preferences screen for a client device.

FIG. 4 is a flow diagram of an example process for generating content in a reference format and sending the content in the reference format to client devices.

FIG. 5 is a flow diagram of an example process for presenting content in a native format, determining that a client device requires the format to be in a different format, and sending the content to the client device.

FIG. 6 is a flow diagram of an example process for receiving content in a reference format, converting the content to a different format, and presenting the content according to the different format.

Like reference numbers and designations in the various drawings indicate like elements.

### DETAILED DESCRIPTION

### Example System of Host Device and Client Devices

### Overview of the System

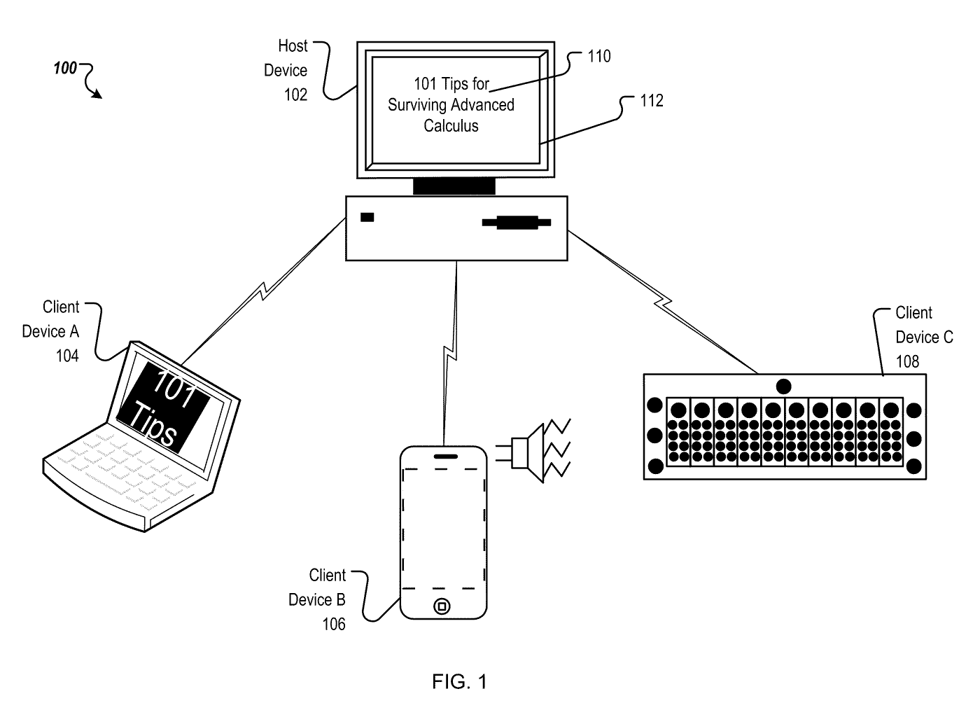

FIG. 1 illustrates an overview of an example system 100 including a host device 102, a client device A 104, a client device B 106, and a client device C 108. While three client devices are shown in FIG. 1, any number of client devices, including more than three and less than three, can be included in the system. The example below will be described in reference to a classroom setting. However, the system can be used in a variety of other contexts, for example, meetings, conferences, sporting events, and other places groups of people gather, as well as to share updates such as airplane arrival and departure schedules at an airport.

A person leading a class uses the host device 102. The host device 102 presents content 110 on its screen 112. The content is the text “101 Tips for Surviving Advanced Calculus.” The content is presented as black text on a white background. While FIG. 1 shows the monitor of the host device as the screen 112, the screen 112 can alternatively or additionally be, for example, a screen onto which the content 110 is projected. While the content 110 is text, the content 110 can alternatively or additionally include other forms of content, including, but not limited to, images, multimedia content, and spoken content (including synthesized speech). Presenting content is not limited to visual presentation, but can alternatively or additionally include other forms of presentation, for example, aural and tactile presentation.

The students in the classroom are shown the content 110. However, some students may not be able to fully experience the content 110. For example, various user disabilities may keep users from experiencing the content 110. Visually impaired students, for example, may not be able to see the content 110 at all, may not be able to read the small font used to display the content 110, or may have difficulty reading dark text on a light background. In addition, students with or without disabilities may have particular preferences for how the content is presented. For example, students may prefer certain font styles, certain spacing, certain natural languages, or have other presentation preferences.

Students in the classroom can have different disabilities, and different preferences for how they experience content 110. To accommodate different needs and different preferences of the students, the host device 102 sends the content 110 in a reference format to various client devices of the students (e.g., client device A 104, client device B 106, and client device C 108). Examples of client devices include, but are not limited to, computers (e.g., client device A 104), mobile devices (e.g., client device B 106), and Braille output devices (e.g., client device C 108). Each of the client devices 104, 106, and 108 receives the content 110 in the reference format, converts the content to a format needed to accommodate a disability of a user of the client device, or a format preferred by the user of the client device, and presents the reformatted content to the user.

For example, client device A 104 converts the content 110 to a text format where the font size is larger, and the text is presented as light text on a dark background. Client device B 106 converts the content 110 from text to synthesized speech. Client device C 108 presents the individual characters of the content 110 as Braille characters.

### Architecture of the System

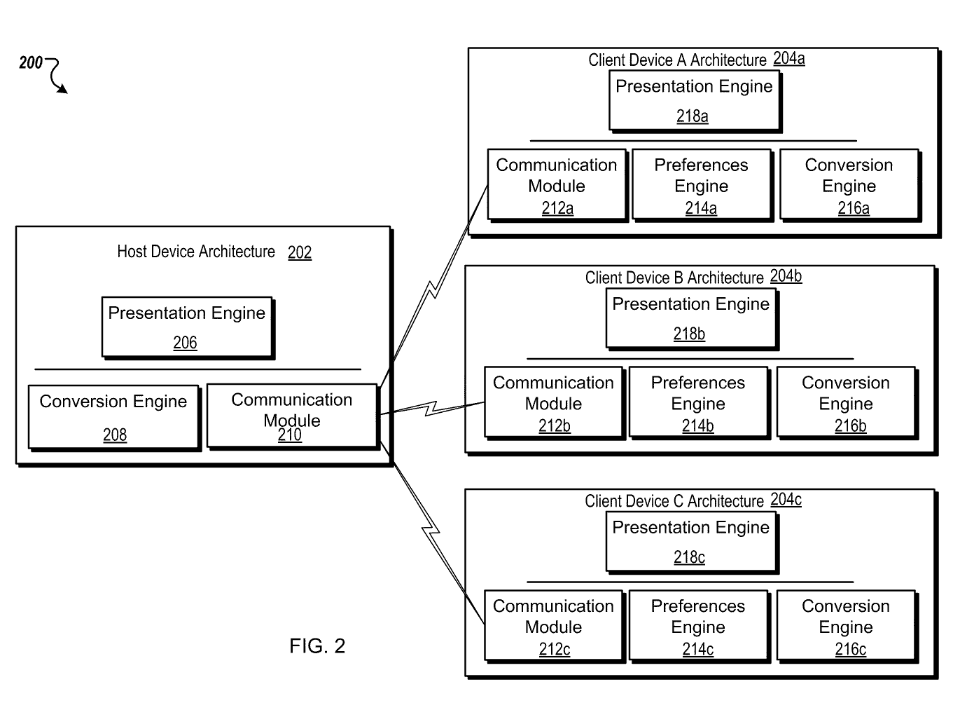

FIG. 2 illustrates an example architecture 200 of the system 100 described above with reference to FIG. 1. The architecture 200 includes a host device architecture 202, and a client architecture 204 for each client device: client device A architecture 204a, client device B architecture 204b, and client device C architecture 204c.

The host device architecture 202 includes a presentation engine 206, a conversion engine 208, and a communication module 210. These components can be communicatively coupled to one or more of each other. Though the components identified above are described as being separate or distinct, two or more of the components may be combined in a single process or routine. The functional description provided herein including separation of responsibility for distinct functions is by way of example. Other groupings or other divisions of functional responsibilities can be made as necessary or in accordance with design preferences.

The presentation engine 206 presents content on the host device 102. For example, the presentation engine can present content on a screen of the host device 102 or can present the content as synthesized speech.

The conversion engine 208 converts the content on the host device 102 to a reference format. The reference format can be defined, for example, according to a communication protocol used by the host device 102 and the client devices 104, 106, and 108 to exchange information. The reference format can be a structured format, for example, Hypertext Markup Language (HTML) formatted text or Extensible Markup Language (XML) formatted text. In some implementations, the reference format is defined according to an application programming interface.

The communication module 210 sends the content formatted according to the reference format to each of the client devices.

Each client device has a similar architecture 204. In general, the device architecture 204 includes a communication module 212, a preferences engine 214, a conversion engine 216, and a presentation engine 218. These components can be communicatively coupled to one or more of each other. Though the components identified above are described as being separate or distinct, two or more of the components may be combined in a single process or routine. The functional description provided herein including separation of responsibility for distinct functions is by way of example. Other groupings or other divisions of functional responsibilities can be made as necessary or in accordance with design preferences. In addition, each client device can have different groupings and divisions of functional responsibilities.

The communication module 212 receives content formatted according to the reference format from the host device. The communication module 212 can also send content formatted according to the reference format, or another, different, format, to other client devices. For example, the different format can be according to a radio protocol, and the communication module 212 can broadcast the content to one or more other devices. As another example, the communication module 212 can provide the content to another device that presents the content on behalf of the client device 104, 106, or 108. For example, the communication module 212 can provide the content to another device that is a speech synthesizer, where the synthesis is actually performed.

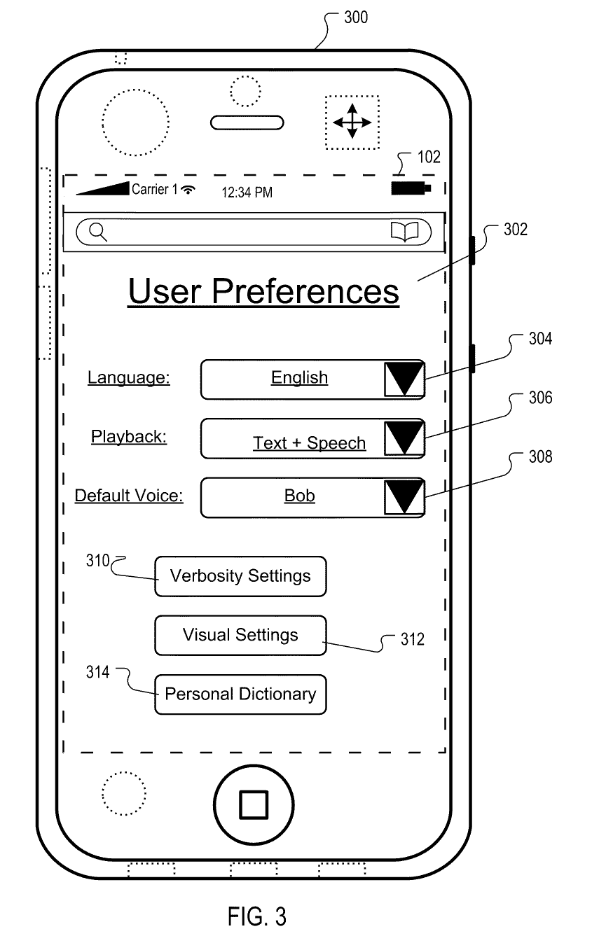

The preferences engine 214 manages user preferences that describe how content is presented to a user of the client device. The preferences engine can manage preferences hardwired into the device as well as preferences specified by users. An example user preference screen through which users can input preferences is described below with reference to FIG. 3. The preferences engine 214 provides these preferences to the conversion engine 216 and the presentation engine 218, for use in converting the content and presenting the content to the user.

Examples of preferences include details of the mechanism through which content is presented to users, details of how the content is formatted, and details of how the content is presented. Examples of the mechanism through which content is presented to users include text, images, video, synthesized speech, aural output, Braille characters, and combinations of these. Details of how the content is formatted include, for example, a preferred language for the content or any abbreviations that a user wishes to use in the content. Details of how the content is presented include, for example, for visual content, a preferred font size, a preferred font type, and contrast setting, and for spoken content, a preferred voice and speaking speed. Preferences are discussed in more detail below with reference to FIG. 3.

The conversion engine 216 converts the content from the reference format to a format preferred by the user of the client device. For example, if the preferred format is speech and the reference format is text, the conversion engine performs a text-to-speech conversion. As another example, if the user prefers that content be presented in a natural language different from the natural language of the content according to the reference format, the conversion engine 216 can translate the content into the preferred language. The conversion engine 216 determines the preferred format details from preferences received from the preferences engine 214. The conversion engine 216 can also convert content into a different format to be sent to other client devices.

The presentation engine 218 presents the content in the format preferred by the user of the client device (e.g., according to the preferences specified by the preferences engine). For example, if the format is speech, the presentation engine 218 presents the speech. If the format is text, the presentation engine 218 presents the text. If the format is Braille, the presentation engine 218 presents the Braille characters.

### Example Preferences Screen for a Client Device

FIG. 3 illustrates an example preferences screen 302 for a client device 300. The preference screen 302 is an example preference screen. Other preferences screens, customized to suit an individual user's needs and preferences, can also be used. The preferences screen 302 allows a user to specify various preferences for how content is presented. For example, the user can specify his or her preferred language using the drop down box 304, his or her preferred playback mode using the drop down box 306, the default voice using the drop down box 308, verbosity settings using the button 310, visual settings using the button 312, and personal dictionary settings using the button 314.

The preferred language is the natural language preferred by the user (e.g., French, English, etc.). The conversion engine 216 can convert content into the natural language preferred by the user.

The preferred playback mode is the way the user prefers to receive content. Example preferred playback modes include Braille, text, and speech (e.g., synthesized speech), and combinations of these (e.g., text plus speech, Braille plus speech, etc.). The conversion engine 216 can convert content into a playback mode preferred by the user.

The default voice is the default voice the device uses for playback that includes synthesized speech. The presentation engine 218 can use the preferred voice when presenting the content.

The verbosity settings are settings that specify how speech sounds, when content is presented as synthesized speech. For example, the verbosity settings can allow a user to specify whether the client device speaks punctuation, whether or how the client device identifies changes in text attributes (e.g., bold, underline, increased font size, etc.), whether or how the client device alerts the listener to hyperlinks, whether descriptions of the screen are spoken, and how much description is spoken, etc. For example, in some implementations, the verbosity settings allow a user to choose from one of several standard verbosity levels (e.g., high, medium, and low), and in some implementations, the verbosity settings allow a user to customize individual settings. In addition, the verbosity settings can allow a user to adjust the speaking rate of the device (e.g., how many words per minute are presented). The verbosity settings can also include the pitch and tone of the synthesized speech.

The visual settings are settings that specify the appearance of content displayed to the user. For example, the visual settings can include a default font size, font type, font weight, grayscale or color, magnification, and contrast settings (e.g., white on black or black on white).

The personal dictionary settings are settings that specify user-specific details of how content is presented. For example, the personal dictionary settings can specify that a user wants to hear or be presented with a summary of content, rather than the content itself. The settings can also include details for the summary, for example, the particular type of content that is being summarized (e.g., web pages, e-mail, word processing documents, etc), and individual settings for that type of content (e.g., for a web page, the details of what is included in the summary, such as do you include the title, the headers, the links, etc.) The personal dictionary settings can also specify particular synonyms that a user wants to use in place of certain words. For example, the personal dictionary settings could specify that a user wishes to be presented with “jk” instead of “just kidding,” “brb” instead of “be right back,” and “NY” instead of “New York.” The personal dictionary settings can also specify a general template for summarizing content. For example, a user familiar with shorthand can request that all content be presented as shorthand. The personal dictionary settings can be manually entered by a user, or can be uploaded, for example, from a file that specifies the dictionary settings for a user.

The preferences described above are example preferences. Other user preference screens, through which users specify a subset of the above preferences, or different preferences, are also possible. In addition, some preference choices may be customized to the individual needs of the users. For example, sighted users may not be presented with text-to-speech options, but may instead choose only from preferences that determine how content is displayed on the device. The choice of preferences can also be determined, for example, by the capabilities of the device. For example, a Braille device may only have one playback mode, Braille characters, and therefore may only present preferences relevant to Braille characters. The available preferences can be recorded in the device, for example, in hardware or software.

### Example Processes

### Example Processes Performed by a Host Device

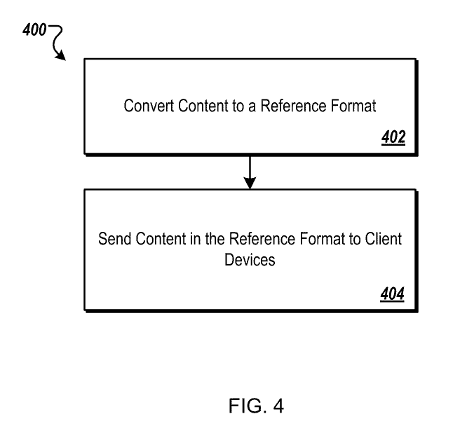

FIG. 4 is a flow diagram of an example process 400 for generating content in a reference format and sending the content in the reference format to client devices. The process is performed, for example, by a host device such as the host device 102.

The host device converts content to a reference format (402), for example, as described above with reference to FIG. 2. The host device sends the content in the reference format to client devices (404), for example, as described above with reference to FIG. 2.

In some implementations, the host device presents the content in a native format on the host device. In these implementations, the host device converts the content from the native format to the reference format.

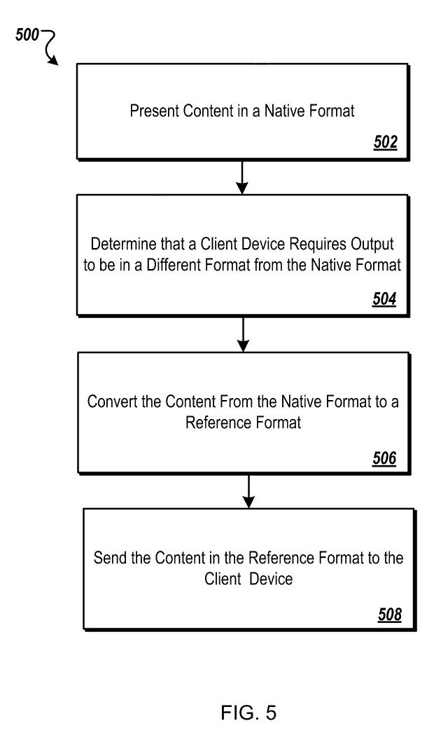

FIG. 5 is a flow diagram of an example process 500 for presenting content in a native format, determining that a client device requires the format to be in a different format, and sending the content to the client device. The process is performed, for example, by a host device such as the host device 102.

The host device presents content in a native format (502), for example, as described above with reference to FIG. 1. The presentation can be, for example, a visual presentation, an aural presentation, a tactile presentation, or a combination of two or more of them.

The host device determines that a client device requires output to be in a different format from the native format (504). The client device can be a client device coupled to the host device, either through a physical connection such as a dock or a cable, or through a network connection. The host device can determine that the client device requires output to be in a different format from the native format, for example, by receiving data from the client device indicating that the device is configured to present content, and that a user of the client device desires the content to be presented according to a different format. The host device converts the content from the native format to a reference format (506), for example, as described above with reference to FIG. 2. The reference format can be selected according to a communication protocol used by the host device and the client device, as described above with reference to FIG. 2. The host device sends the content in the reference format to the client device (508), for example, as described above with reference to FIG. 2.

The host device can also determine that multiple client devices require output to be in a different format from the native format, and send the content in the reference format to each of the multiple client devices.

### Example Process Performed by a Client Device

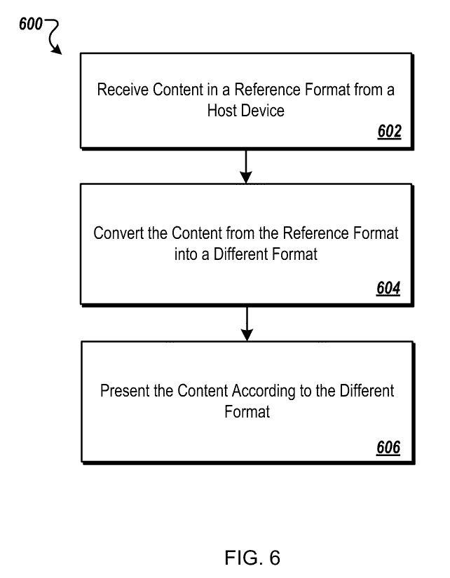

FIG. 6 is a flow diagram of an example process 600 for receiving content in a reference format, converting the content to a different format, and presenting the content according to the different format. The process is performed, for example, by a client device. Example client devices include the client devices 104, 106, and 108.

The client device receives content in a reference format from a host device (602), for example, as described above with reference to FIG. 2. The client device converts the content from the reference format into a different format (604), for example, as described above with reference to FIG. 2. In some implementations, the different format accommodates a disability of a user of the device. The client device presents the content according to the different format (606), for example, as described above with reference to FIG. 2.

In some implementations, the client device converts the content into the different format, and presents the content according to the different format, in real time, as the content is received in the reference format from the host device. For example, the host device can stream the content in one or more packets to the client device. The client device can receive each packet, begin converting the content included in the packet as soon as the packet is received, and then present the converted content as soon as the conversion is completed.

In some implementations, the client device sends the content to one or more additional client devices. The client device can send the content in the reference format, or can convert the content to a different reference format, and send the content according to the different reference format. Each of the additional client devices receives the content, converts it into a different format, and presents the content according to the different format. This allows the content to be further disseminated.

The features described can be implemented in digital electronic circuitry, or in computer hardware, firmware, software, or in combinations of them. The features can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. Alternatively or in addition, the program instructions can be encoded on a propagated signal that is an artificially generated signal, e.g., a machine-generated electrical, optical, or electromagnetic signal, that is generated to encode information for transmission to suitable receiver apparatus for execution by a programmable processor.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be coupled by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. For example, each of the modules 206, 208, 210, 212, 214, 216, and 218 need not perform all, or any, of the functionality attributed to that module in the implementations described above, and all or part of the functionality attributed to one module may be performed by another module, another additional module, or not performed at all. Accordingly, other implementations are within the scope of the following claims.

What is claimed is:

1. A system comprising:
a host device configured to perform operations comprising:
sending content in a reference format to a plurality of client devices;
a first client device configured to perform operations comprising:
receiving the content in the reference format from the host device;
converting the content from the reference format into a different first format; and
presenting the content according to the first format; and
a second client device configured to perform operations comprising:
receiving the content in the reference format from the host device;
converting the content from the reference format into a second format, the second format being different from the reference format and the first format; and
presenting the content according to the second format.

2. The system of claim 1, the host device further configured to perform operations comprising:
presenting the content in a native format on the host device; and
converting the content from the native format to the reference format.

3. The system of claim 2, where the reference format is specified by a communication protocol used by the first, second, and third devices.

4. The system of claim 2, where the native format is text of a first size, and the first format is text of a second size, where the second size is larger than the first size.

5. The system of claim 2, where the native format is text, and the first format is synthesized speech.

6. The system of claim 2, where the native format is text, and the first format is Braille.

7. The system of claim 2, where the native format is text in a first language, and the first format is text in a different second language.

8. The system of claim 1, where the first client device is further configured to convert the content into the first format and present the content according to the first format in real time as the content is received in the reference format from the host device.

9. The system of claim 1, where the first client device and the second client device are mobile devices.

10. The system of claim 1, where the first format used by the first client device accommodates a disability of a first user of the first client device, and the second format used by the second client device accommodates a disability of a second user of the second client device.

11. The system of claim 1, wherein the first client device is further configured to perform operations comprising: sending the content to one or more client devices.

12. The system of claim 11, wherein the first client device sends the content in the reference format.

13. The system of claim 12, wherein a third client device in the one or more client devices is configured to perform operations comprising:
receive the content in the reference format from the first client device;
convert the content into a third format, the third format different from the reference, first, and second formats; and
present the content according to the third format.

14. A computer-implemented method, comprising:
presenting, with a host device, content in a native format;
determining, in the host device, that a first client device in communication with the host device requires output to be in a format different from the native format;
converting, in the host device, the content from the native format to a reference format that can be processed by the first client device; and
sending the content in the reference format from the host device to the first client device.

15. The method of claim 14, further comprising:
selecting the reference format according to a communication protocol used by the host device and the first client device.

16. The method of claim 14, where:
the first client device is configured to receive the content in the reference format, convert the content to a first format, and present the content according to the first format; and
the first format is different from the native and reference formats.

17. The method of claim 14, where the first client device is further configured to send the content to a second client device.

18. The method of claim 14, further comprising:
determining, in the host device, that a plurality of client devices in communication with the host device require output to be in formats different from the native format; and
sending the content in the reference format from the host device to each client device in the plurality of client devices.

19. A computer-readable medium having instructions stored thereon, which, when executed by a processor, causes the processor to perform operations comprising:
presenting, with a host device, content in a native format;
determining, in the host device, that a first client device in communication with the host device requires output to be in a format different from the native format;
converting, in the host device, the content from the native format to a reference format that can be processed by the first client device; and
sending the content in the reference format from the host device to the first client device.

20. The computer-readable medium of claim 19, the instructions further operable to cause the processor to perform operations comprising sending the content in the reference format to a second client device.

21. The computer-readable medium of claim 19, where the first client device is further configured to perform operations comprising:
receiving the content in the reference format, convert the content to a first format, and present the content according to the first format, where the first format is different from the native and reference formats; and
sending the content in the reference format to a third client device.

22. A system comprising:
a processor;
a display device;
one or more storage devices; and
a computer readable medium coupled to the processor and including instructions, which, when executed by the processor, causes the processor to perform operations comprising:
presenting, with a host device, content in a native format;
determining, in the host device, that a first client device in communication with the host device requires output to be in a format different from the native format;
converting, in the host device, the content from the native format to a reference format that can be processed by the first client device; and
sending the content in the reference format from the host device to the first client device.
